(19) United States
(12) Patent Application Publication
(10) Pub. No.: US 2020/0367679 A1
(43) Pub. Date: Nov. 26, 2020

(54) SCREW-ON SPOON BOWL

(71) Applicant: Adam Leffler, Lake Elsinore, CA (US)

(72) Inventor: Adam Leffler, Lake Elsinore, CA (US)

(21) Appl. No.: 16/311,042

(22) PCT Filed: Jul. 18, 2017
(86) PCT No.: PCT/IB2017/001442

§ 371 Date: Dec. 18, 2018

Related U.S. Application Data
(60) Provisional application No. 62/363,944, filed on Jul. 19, 2016.

(51) Int. Cl. A47G 21/04; A61J 7/00

(52) U.S. Cl. CPC A47G 21/04; A61J 7/0023

(57) ABSTRACT

A spoon for administering a medication includes a bowl and a handle. Various configurations of the bowl or handle can allow a carrier medium or medication to be more easily dispensed.

### CLAIM OF PRIORITY UNDER 35 U.S.C. § 119

This application claims priority to U.S. Provisional Patent Application Ser. No. 62/363,944 entitled “SCREW-ON SPOON BOWL”, filed on Jul. 19, 2016, which is hereby expressly incorporated by reference herein.

### TECHNICAL FIELD OF THE INVENTION

The present invention generally relates to spoons and particularly spoons capable of dispensing a measured amount of a fluid or paste such as pudding or apple sauce providing benefits to caregivers and the physically impaired.

### BACKGROUND OF THE INVENTION

In nursing homes, schools, prisons, hospitals, hospices and other skilled nursing facilities it is often required to administer medicine to a patient who is either not able to self-administer or where it would be more beneficial to assure that the medicine be administered by a caregiver. In a typical environment the caregiver verifies the temperature of the medium such as applesauce; a spoon is dipped into the applesauce and a medicine is crushed into the applesauce and then administered to the patient. Problems with this technique are that the medium such as applesauce may become adulterated or cross contaminated as several spoons are dipped into the medium. The temperature can rise over time making the medium less desirable or dangerous if left in a warm environment for too long of a period. In addition, because the medication is ground and added to the carrier, if not all of the carrier medium is consumed, then a less than medically effective amount of medicine could be administered.

### SUMMARY OF THE INVENTION

The invention comprises a threaded collar, a base, an attached spoon bowl and inwardly facing teeth capable of engaging and twisting a frangible tab connected to the end of a tube. The threaded collar is capable of engaging the threads at the end of the tube before the teeth engage the frangible tab, thereby allowing the tube and spoon bowl to be shipped in a partially engaged configuration. Once the combination is ready for use, the threaded collar may be twisted further and the teeth will engage the frangible tab and sever the tab from the tube. A hole will now be exposed through which the contents of the tube may be squeezed. The contents pass through the exposed hole, around the severed tab and through an opening in the base out into the spoon bowl. By varying the pressure on the squeezable tube, a desired amount of contents may be dispensed into the spoon bowl. Within the tube may be a medium such as a gel, a gelatin, a pudding, or natural foods such as applesauce. In some embodiments a medically effective amount of medication has been premixed into the carrier medium before sealing the carrier medium in the tube. A protective seal then covers the top of the bowl and the entire device is pasteurized so that the combination device can then be packed in a sterile container and will remain sterile until administration. The spoon bowl may be constructed of food grade plastic to survive the pasteurization/sterilization process without any detrimental effects. In some embodiments, a more permanent screw-on spoon bowl may be utilized which is made of metal and is washed and re-used by threading it on a new tube.

In one embodiment, a combination screw-on spoon bowl and tube may be used to administer a medication. The combination may comprise a screw-on spoon bowl comprising a threaded collar, a hollow base and a spoon bowl. The threaded collar is sized so as to engage a threaded end of a tube. Inside the hollow base are teeth which engage a frangible tab on the end of the tube. Twisting of the hollow base with its teeth severs the tab from the tube exposing an opening which is in communication with the spoon bowl. This allows a carrier medium contained within the tube to be expelled from the tube through the threaded collar and hollow base into the bowl.

In another embodiment, a re-usable screw-on spoon bowl is cleaned and threaded on a tube containing carrier medium such as apple sauce. As the threaded collar engages the threads on the end of the tube, the inwardly facing teeth on the inside of the hollow base engage the frangible tab and sever it from the tube. The screw-on spoon bowl may then be unthreaded and pulled from the tube allowing the frangible tab to fall from the collar, or the screw-on spoon bowl may continue to be threaded onto the end of the tube and the carrier medium is expressed into the hollow base around the now-severed frangible tab and through a hole in the base into the spoon bowl. The amount of medium expressed is controlled by pressure placed on the outside of the tube by squeezing until a level of medium is reached in the spoon bowl. Graduated lines may be placed inside the bowl to indicate how much medium has been expressed. Graduated lines may also be placed on the outside of the tube to generally show how much medium is left in the tube if the tube is constructed of a material that lends itself to that technique. The tube may also be transparent and held in a vertical position to show approximately how much is left. This will usually only be used to verify that a full dose remains in the tube to avoid having to administer two partially full bowls to a patient.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an embodiment of a screw-on spoon bowl attached to a tube of delivery medium;

FIG. 2 shows an embodiment having an opening in communication with the hollow base and the spoon bowl;

FIG. 3 shows an embodiment having a hollow base within which are formed teeth capable of engaging a frangible tab on the end of a tube (not shown);

FIG. 4 is a view of an embodiment combing a carrier medium in a tube which is sealed with a frangible tab, also shown is a screw-on spoon bowl which is configured to screw on to the tube;

FIG. 5 shows another embodiment having a hollow base within which are formed engagement teeth capable of engaging a frangible seal tab on the end of a tube (not shown);

FIG. 6 shows a cross sectional view of the embodiment shown in FIG. 3;

FIG. 7 shows a cross sectional view of the embodiment shown in FIG. 5;

FIG. 8 shows a further embodiment having an opening in communication with the hollow base and the spoon bowl.

### DETAILED DESCRIPTION

A description of embodiments of the present invention will now be given with references to the Figures. It is expected that the present invention may take many other forms and shapes, hence the following disclosure is intended to be illustrative and not limiting, and the scope of the invention should be determined by reference to the appended claims.

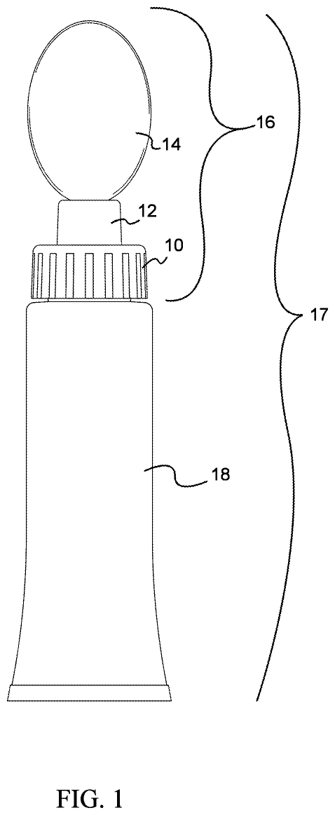

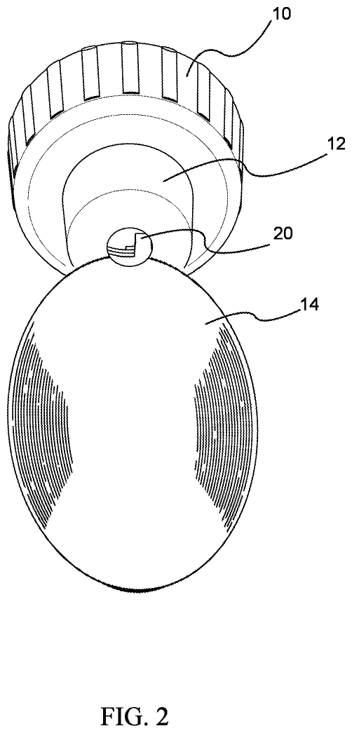

Turning now to FIG. 1, a threaded collar 10, a base 12, an attached spoon bowl 14 comprise the screw-on spoon bowl 16. Threaded collar 10 is capable of engaging the threads at the end of a tube 18 to connect screw-on spoon bowl 16 to tube 18. The screw-on spoon bowl 16 and the tube 18 comprise the screw-on spoon bowl assembly 17. Once the combination of tube 18 and screw-on spoon bowl 16 are ready for use, pressure applied to tube 18 will force the contents of tube 18 through threaded collar 10 which is hollow and through a channel in base 12 out through an exit opening 20 (shown in FIG. 2). Referring now to FIG. 2, it can be seen that the contents of the tube will be expressed through exit opening 20 into bowl 14 in an amount that may be controlled by the pressure exerted on tube 18.

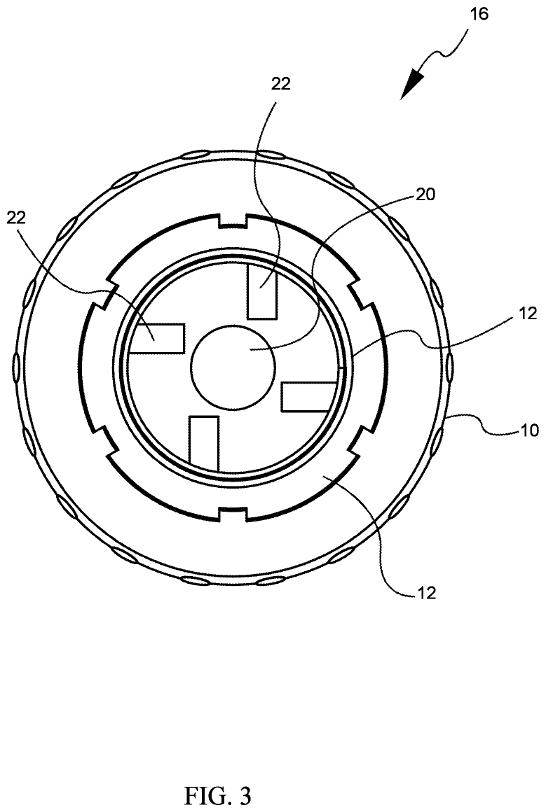

FIG. 3 shows an embodiment that shows collar 10 and base 12 when viewed along the axis of passage of the contents of tube 18. Exit opening 20 is shown. Exit opening 20 is in fluid communication between tube 18 and bowl 14 (shown in FIG. 1). In some embodiments, inside base 12 are several teeth 22 which project inwardly to engage a tab 24 (shown in FIG. 4) which seals the end of tube 18. The engagement of the several teeth 22 with the frangible tab 24 occurs as the base 10 is threaded upon the threads of the tube 18 into the ready for use assembly 17 (shown in FIG. 1). This can best be understood by comparing FIG. 3 and FIG. 6 with FIG. 4 where frangible tab 24 can be seen from the screw-on spoon bowl assembly 17 prior to the engagement of the threads of base 10 with the threads 26 of tube 18.

In this embodiment, threaded collar 10, base 12, attached spoon bowl 14 and inwardly facing teeth 22 are capable of engaging and twisting the frangible tab 24 connected to the end of a threaded portion 26 of tube 18. Threaded collar 10 is capable of engaging the threaded end 26 of tube 18 prior to use. The combination may be shipped in that configuration or may be placed in that configuration prior to use. This keeps the contents of tube 18 sealed. When the users wishes to provide the contents to the patient, threaded collar 10 is threaded further on to threaded end 26 so that teeth 22 inside of base 12 now engage frangible tab 24 and shear it off of the end of tube 18 or optionally exposes an opening allowing fluid communication with exit opening 20. Frangible tab 24 is captured inside base 12 and the contents of tube 18 flows around it as the contents are expressed from tube 18. In this embodiment, teeth 22 (shown in FIGS. 3 and 6) are not allowed to engage tab 24 (FIG. 4) until ready for use, but screw-on spoon bowl 16 may still be partially threaded on to tube end 26 to be stored or shipped in a partially engaged configuration. Once the combination 17 is ready for use, the threaded collar may be twisted further and the teeth will engage the frangible tab and sever the tab from the tube or exposes an opening in the tube. A hole in the end of tube 18 will now be exposed through which the contents of tube 18 may be squeezed. The contents pass through the exposed hole, around severed tab 24 and through opening 20 in base 12 out into spoon bowl 14. By varying the pressure on the squeezable tube 18, a desired amount of contents may be dispensed into spoon bowl 14.

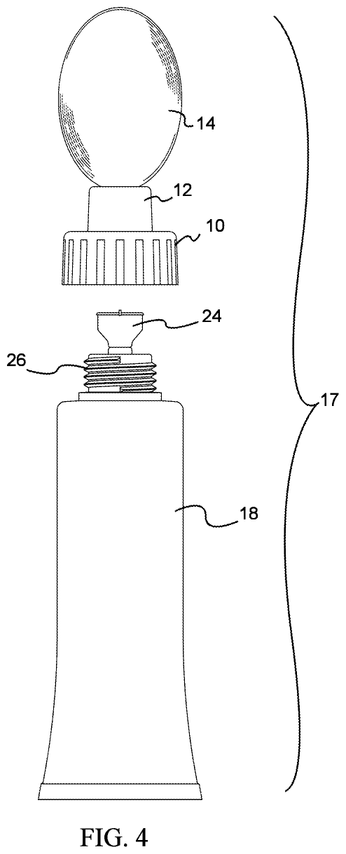

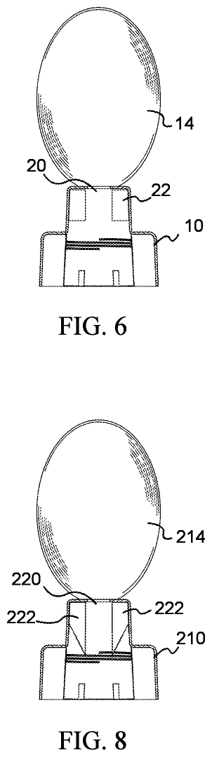

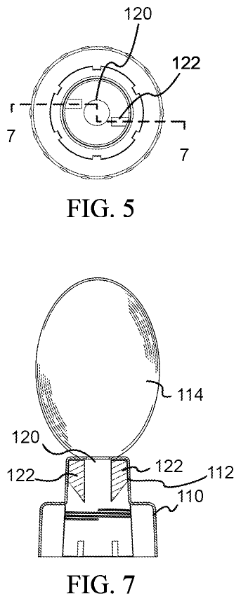

In another embodiment, FIGS. 5 and 7 show a collar 110 and a base 112 when viewed along the axis of passage of the contents of tube 18. Exit opening 120 is shown. Exit opening 120 is in fluid communication between tube (not shown) and bowl 114. In this embodiment, inside base 112 are several engagement teeth 122 which project inwardly to engage a seal tab (not shown) which seals the end a tube. The engagement of the several teeth 122 with the frangible seal tab occurs as the base 110 is threaded upon the threads of the tube which comprises screw-on spoon bowl assembly.

In this embodiment, threaded collar 110, base 112, attached spoon bowl 114 and inwardly facing teeth 122 are capable of engaging the frangible seal tab connected to the end of a threaded portion of tube. Threaded collar 110 is capable of engaging the threaded end of tube prior to use without penetrating the frangible seal tab until the threaded connection is completed and fluid contents are desired. The combination may be shipped in a partially threaded configuration or unconnected and in a package configuration prior to use. This keeps the contents of tube sealed. When the users wishes to provide the contents to the patient, threaded collar 110 is completely threaded on to threaded end of the tube so that teeth 122 inside of base 112 now sever frangible seal tab of the tube exposing an opening allowing fluid communication with exit opening 120. Frangible seal tab is openly retained to the tube and captured inside base 112 and the contents of tube flow past it as the contents are expressed from tube.

In further embodiment, FIG. 8 shows a collar 210 and a base 212 when viewed along the axis of passage of the contents of a tube (similar to the tube 18 shown in FIG. 1). Exit opening 220 is shown. Exit opening 220 is in fluid communication between tube and bowl 214. In this embodiment, inside base 212 are several puncture teeth 222 which project inwardly to engage a seal tab (not shown) which seals the end the tube. The engagement of the several teeth 222 with the frangible seal tab occurs as the base 210 is threaded upon the threads of a tube which comprises screw-on spoon bowl assembly.

In this embodiment, threaded collar 210, base 212, attached spoon bowl 214 and inwardly facing puncture teeth 222 are capable of engaging the frangible seal tab connected to the end of a threaded portion of tube as the screw-on spoon bowel is assembled to the tube to penetrate the seal tab fluidly exposing the contents of the tube to the channel opening 220. This combination may be shipped unconnected in a package configuration being ready for use at the point of application or optionally supplied separately. This keeps the contents of tube sealed. When the users wishes to provide the contents to the patient, the screw-on spoon bowel is presented to the tube whereby threaded collar 210 is threaded on to threaded end of the tube so that puncture teeth 222 inside of base 212 sever frangible seal tab of the tube exposing the channel opening allowing fluid communication with exit opening 220.

The teeth 22, 122, and 222 of the various embodiments, shown and described, have been shown and describe without limitation and it is recognized that theses “teeth” can be made in various configurations being capable of puncturing, piercing, tearing, ripping, slitting, shredding or opening any frangible seal or tab of a tube to provide a fluid communicable channel Further, it is recognized that the present invention may have just one tooth or a plurality of teeth for opening the frangible seal or tab or a tube.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A screw-on spoon bowl for administering a paste or fluid from a tube, the screw-on spoon bowl comprising:
a spoon bowl attached to a base, said base comprising a threaded collar, said threaded collar being configured to thread on to an end of a tube;
one or more teeth projecting inwardly into a hollow channel through said base, said one or more teeth being configured to rupture a frangible seal or tab on the end of the tube;

2. The screw-on spoon bowl as recited in claim 1, wherein said threaded collar is attached within said base.

3. The screw-on spoon bowl as recited in claim 1, wherein said one or more teeth is a plurality of teeth, each tooth being configured to engaged the frangible tab on the end of the tube.

4. The screw-on spoon bowl as recited in claim 1, wherein said one or more teeth are configured to engage the frangible seal, only after said threaded collar has engaged the first thread of the threads on the end of the tube and before said threaded collar has engaged all the threads on the end of the tube.

5. The screw-on spoon bowl as recited in claim 1, wherein said one or more teeth are configured to engage said frangible tab, only after said threaded collar has engaged the first thread of the threads on the end of the tube.

6. A screw-on spoon bowl assembly for administering a paste or fluid from a tube, the assembly comprising:
a tube, said tube comprising a body configured for containing paste or fluid, threads, and a frangible seal tab affixed to the end of the threads; and
a screw-on spoon bowl; said screw-on spoon bowl configured to engage the frangible seal tab and threads when screwed on to the end of said tube,

7. The screw-on spoon bowl assembly as recited in claim 6, wherein said screw-on spoon bowl comprises spoon bowl attached to a base, said base being attached to a threaded collar, said threaded collar being configured to thread on to the end of said tube; and teeth projecting inwardly into a hollow channel through said base; wherein said frangible seal tab is temporarily affixed to the end of threads on said tube; said teeth configured to engage said frangible tab as said threaded collar is screwed on to the end of said tube.

8. The screw-on spoon bowl assembly as recited in claim 7, wherein said teeth are configured to engage said frangible seal tab, only after said threaded collar has engaged the first thread of said threads on the end of said tube.

9. The screw-on spoon bowl assembly as recited in claim 7, wherein said teeth configured to completely remove said frangible seal tab from the end of said tube.

10. The screw-on spoon bowl assembly as recited in claim 9, wherein said base of said screw-on spoon bowl configured to completely retain said frangible seal tab within said hollow channel.

11. The screw-on spoon bowl as recited in claim 7, wherein said teeth are configured to engage the frangible seal, only after said threaded collar has engaged the first thread of said threads on the end of said tube and before said threaded collar has engaged all the threads on the end of said tube.

12. A method for administering a paste or liquid from a tube, said method comprising the steps of;
placing on the end of a threaded tube a spoon bowl.

13. The method of claim 12 wherein the threaded tube comprises a frangible tab and the spoon bowl comprises teeth and a threaded collar; further comprising the step of; rotationally engaging said teeth with said frangible tab, only after said threaded collar has engaged the first thread of said threads on the end of said tube.

14. The method of claim 13 further comprising the step of; exposing a graduated amount of paste or liquid onto said spoon bowl by pressing said tube.

15. A method for administering a paste or liquid from a tube, said method comprising the steps of:
screwing on to the end of a tube having a threaded end a spoon bowl; screwing the spoon bowl further so that teeth within the base for the spoon bowl engage a seal tab on the end of the tube to shear the tab and allow paste or fluid from the tube to pass through the base and into the spoon bowl when the tube is squeezed.

16. The method of claim 15 further comprising the step of; exposing a graduated amount of paste or liquid onto said spoon bowl by pressing said tube.

17. The method of claim 15 wherein the step of screwing the spoon bowl further so that teeth within the base for the spoon bowl engage a seal tab on the end of the tube to shear the tab and allow paste or fluid from the tube to pass through the base and into the spoon bowl when the tube is squeezed is screwing the spoon bowl further so that teeth within the base for the spoon bowl engage a seal tab on the end of the tube to shear off the tab by piercing the seal, retentively retaining sheared off tab and allows paste or fluid from the tube to pass through the base and into the spoon bowl when the tube is squeezed.

18. The method of claim 15 wherein the step of screwing the spoon bowl further so that teeth within the base for the spoon bowl engage a seal tab on the end of the tube to shear the tab and allow paste or fluid from the tube to pass through the base and into the spoon bowl when the tube is squeezed is screwing the spoon bowl so that teeth within the base for the spoon bowl immediately engage a seal tab on the end of the tube to exposingly shear the tab and allow paste or fluid from the tube to pass through the base and into the spoon bowl when the tube is squeezed.

19. The screw-on spoon bowl assembly as recited in claim 6, wherein said tube is transparent.

20. The screw-on spoon bowl assembly as recited in claim 1, wherein said spoon bowl comprises graduated lines.
